(19) United States
(12) Patent Application Publication
(10) Pub. No.: US 2012/0060699 A1
(43) Pub. Date: Mar. 15, 2012

(54) COOKING GRILL WITH REVOLVING CLOSURE

(76) Inventors: David C. Shidler, Holland, MI (US); Mark L. Graham, Holland, MI (US)

(21) Appl. No.: 12/881,573

(22) Filed: Sep. 14, 2010

(51) Int. Cl. A47J 37/07

(52) U.S. Cl. 99/341

(57) ABSTRACT

A cooking grill includes a food cooking chamber that is at least partially defined by a lid assembly having stationary side walls and a closure panel moveable by rotation around a vertical axis disposed inwardly of the stationary side walls (i.e., toward the center of the cooking chamber). Alternative means may be provided for allowing movement of the closure panel along a path concentric with stationary side walls of the lid assembly between a closed position and an open position. Movement of the closure panel with respect to the lid member defines a variably sized opening between a vertical edge of the closure panel and a vertical edge of the lid member while leaving a roof section of the lid member positioned over the food on the food cooking surface to better retain heat when the closure panel is in an open position.

### FIELD OF THE INVENTION

This invention relates generally to the field of outdoor cooking grills including barbeque grills and/or smoker grills.

### BACKGROUND OF THE INVENTION

Outdoor cooking grills that cook foods by direct heating such as over a fire are generally referred as barbeque grills. Outdoor grills that cook food with indirect heating and smoking are generally referred to as smoker grills. In both types of grills, a cooking chamber is typically provided on a support structure, such as a cart or the like, and a lid or cover is hingedly mounted to the structure to define a cooking enclosure when the lid is in a closed position, and allow access to the food when the lid is in an open position.

For a typical barbeque grill, a heat source such as charcoal or propane is combusted directly below the cooking surface (e.g., below a grate). For a typical smoker grill, a fire box or combustion chamber is provided for maintaining a fire of smoldering wood or other combustible material. The fire box and cooking chamber of smoker grills are arranged so that the food is not cooked or heated by radiant energy emitted from the fire. Rather, the fire box and the cooking chamber are in fluid communication, such that smoke and heated combustion products pass from the fire box and through the cooking chamber, slowly cooking and imparting an aromatic flavor to the food.

### SUMMARY OF THE INVENTION

In accordance with certain embodiments of the invention, there is provided a cooking grill having a food cooking chamber that includes a lid assembly having stationary side walls and a closure panel defining a side wall of the food cooking chamber that is moveable with respect to the stationary side walls between a closed position and an open position.

In certain embodiments, the closure panel is moveable by rotation around a vertical axis at the center of the cooking chamber.

In accordance with certain embodiments of the invention, the closure panel is moveable along a path concentric with the stationary side walls.

In accordance with certain embodiments of the invention, there is provided a cooking grill having an upper housing portion containing a food cooking chamber, and a lower housing portion containing a combustion chamber located below the food cooking chamber, the lower housing portion having a window through which flames from fuel burning in the combustion chamber can be seen.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is an elevational side view of a cooking grill in accordance with certain embodiments of the invention.

FIG. 2 is an enlarged sectional view of the lid assembly shown in FIG. 3, as seen in detail III, illustrating a mechanism for rotating a closure panel with respect to the stationary side walls of the lid assembly in FIG. 2.

FIG. 3 is a perspective view of the grill shown in FIG. 1 with portions of the housing broken away to show internal details.

FIG. 4 is an enlarged fragmentary side view of the grill shown in FIG. 1 with portions broken away to show the internal burn pot and fuel feeding mechanism of the grill.

### DETAILED DESCRIPTION OF THE PREFERRED EMBODIMENTS

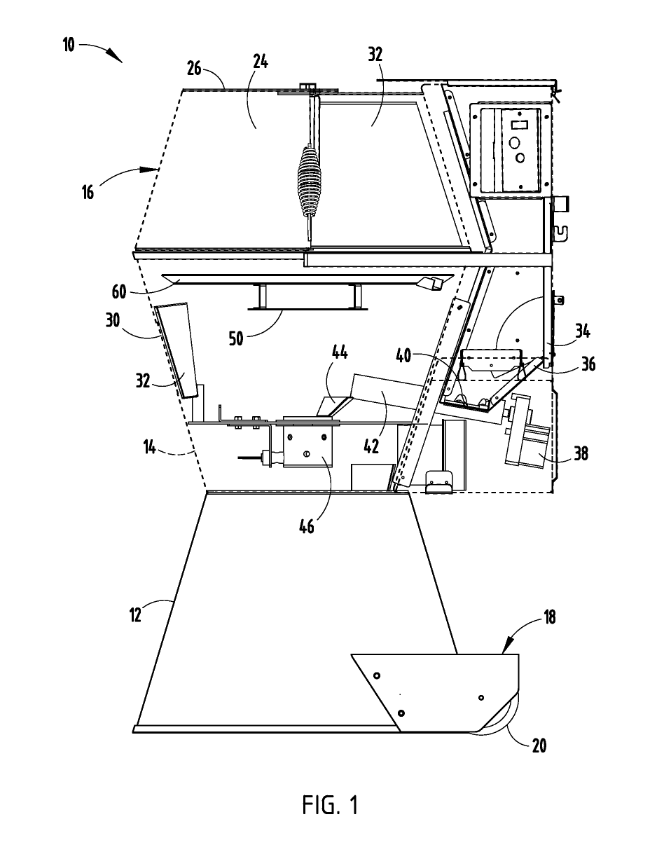

As shown in FIG. 1, there is a grill 10 having a frustroconical base 12, an inverted frustroconical lower housing portion 14 on base portion 12, and a frustroconically shaped upper housing portion or lid assembly 16 on the lower housing portion 14.

In order to facilitate transportability of grill 10, a wheel assembly 18, including a pair of wheels 20 (only one of which is shown) is affixed to base 12.

It will be appreciated that the novel and inventive features of the invention may be employed on barbeque grills, such as charcoal grills or propane grills or on smoker grills, as illustrated in greater detail herein. In the case of smoker grills, the novel and inventive features disclosed herein may be employed on grills designed for using a variety of different fuels, such as corn kernels, seeds, wood chips, and/or other pelleted fuels.

Lid assembly 16 including a semi-frustroconically shaped stationary lid member 22 and a semi-frustroconically shaped closure panel 24 that is moveable with respect to the stationary lid member 22 between a closed position and an open position. While in the illustrated embodiment, lid member 22 and closure panel 24 together define a frustroconically shaped upper housing portion 16 when closure member 24 is in the closed position, other suitable shapes for the upper housing portion include hemispherical and other spherical sections, and cylinders.

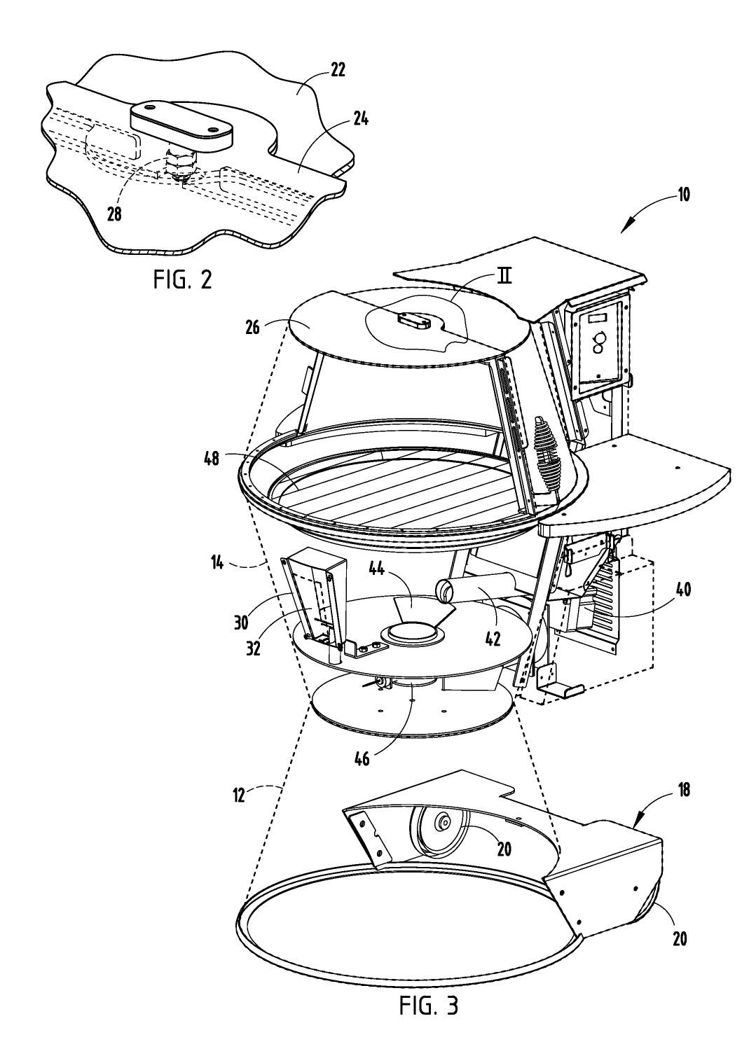

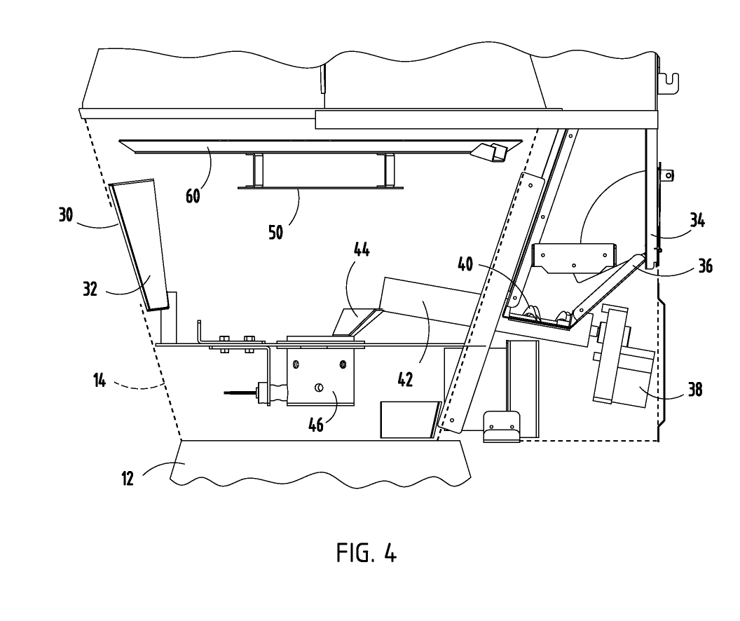

As shown in greater detail in FIG. 3, closure panel 24 is pivotally attached to a top or roof panel 26 of stationary lid member 22, whereby closure panel 24 is rotatable around a vertical axis that is located inwardly of sidewalls 23 of the lid member approximately at the center of the cooking chamber. Closure panel 24 is moveable along a path that is concentric with the stationary side walls of lid member 22. A suitable pivot connection 28 that facilitates the desired movement of closure panel 24 with respect to stationary lid member 22 is shown in FIG. 2.

Movable closure panel 24 in combination with lid member 22 define a cooking chamber that is openable by movement of the closure panel with respect to the lid member to define a variably sized opening between a vertical edge of the closure panel and a vertical edge of the lid member, leaving a roof section of the lid member positioned over the food on the food cooking surface to better retain heat when closure panel 24 is in an open position.

FIG. 3 shows a grill in accordance with certain embodiments of the invention having a window 30 framing and holding a transparent member 32 (e.g., glass) to allow the flames from fuel being burned in a fire box or combustion chamber of the grill to be seen when the closure panel is in the closed position. This allows a person operating the grill to easily determine whether the fuel is being properly burned, and provides a pleasant visual ambiance, especially while grilling in the evening. Window 30 is especially useful for confirming proper operation of a smoker grill, in which indirect heating is used and the flame cannot be seen from the food cooking chamber.

In FIG. 4, there is shown internal features of a smoker grill 10. In the illustrated embodiment, fuel, such as fuel pellets, wood chips, corn kernels, or the like, are conveyed from a storage hopper to an auger assembly comprising an electric motor 38 that drives an auger screw 40 up an auger tube 42 and down a fuel feed chute 44 into fire box 46. A controller unit is provided for regulating the rate at which fuel is added to the fire box, typically to maintain a selected temperature in the food cooking chamber.

The novel lid assembly 16 of the invention has several advantages over conventional lid assemblies. First, the arrangement allows the grill operator to check on the food or turn the food without fully opening the enclosure, thereby reducing heat loss as compared with conventional lid assemblies. In addition, lid assembly 16 may be left in any desired open orientation, such as from zero degrees to 180 degrees (i.e., for the illustrated embodiment, anywhere between fully open and fully closed) without requiring a prop or lid positioner, which can be awkward and potentially dangerous. Also, unlike conventional lid assemblies from which soot deposits can be jarred loose if the handle is accidentally released during opening or closing of the lid, the closure panel in the illustrated embodiments of the invention can be left in any desired position between fully opened and fully closed without the need to hold the handle or without using a prop or a positioner. In the illustrated embodiment, a grate 48 is positioned on an upper section of lower housing portion 14 above fire box 46. Grate 48 or other food support member defines the bottom of the food cooking chamber. In the illustrated embodiment, a flame deflector 50 and a flavor disc 60 are positioned between the food cooking chamber and fire box 46 to prevent flames from impinging directly on the food and to prevent radiant energy from being transferred directly from the burning fuel to food in the food cooking chamber. Flavor disc 60 can also be configured to help drain grease and food drippings away from the cooking chamber.

The novel lid assembly and window of the invention can be used with either smoke grills, such as illustrated, or with barbeque grills in which the fuel, such as charcoal or natural gas, can be burned in the lower housing portion 14, with heat and flame from the burning fuel radiating directly toward food on grate 48.

The above description is considered that of the preferred embodiment(s) only. Modifications of the invention will occur to those skilled in the art and to those who make or use the invention. Therefore, it is understood that the embodiment(s) shown in the drawings and described above are merely for illustrative purposes and not intended to limit the scope of the invention, which is defined by the following claims as interpreted according to the principles of patent law, including the doctrine of equivalents.

The invention claimed is:

1. A cooking grill comprising:
a food cooking chamber at least partially defined by a lid assembly having stationary side walls and a closure panel moveable by rotation around a vertical axis at the center of the cooking chamber.

2. The grill of claim 1, wherein the stationary side walls and the closure panel define a cooking chamber having a shape that is a section of a sphere, cylinder, or cone.

3. The grill of claim 1, wherein the food cooking chamber comprises a stationary lid member having a semi-frustroconical shape, and a closure panel having a frustroconical shape, the stationary lid member and the closure member together defining a frustroconical food cooking chamber.

4. The grill of claim 1, wherein the stationary lid member has a semi-cylindrical shape, and the closure panel has a semi-cylindrical shape, the stationary lid member and the closure panel together defining a cylindrical food cooking chamber.

5. The grill of claim 1, further comprising a housing portion located below the food cooking chamber and having a window through which flames from fuel burning in a combustion chamber located in the lower housing member can be seen.

6. The grill of claim 5, in which the window has a transparent pane.

7. The grill of claim 6, in which the transparent pane is a glass pane.

8. A cooking grill comprising:
a food cooking chamber at least partially defined by a lid assembly having stationary side walls and a closure panel moveable along a path concentric with the stationary side walls, between a closed position and an open position.

9. The grill of claim 8, wherein the stationary side walls and the closure panel define a cooking chamber having a shape that is a section of a sphere, cylinder, or cone.

10. The grill of claim 8, wherein the food cooking chamber comprises a stationary lid member having a semi-frustroconical shape, and a closure panel having a frustroconical shape, the stationary lid member and the closure member together defining a frustroconical food cooking chamber.

11. The grill of claim 8, wherein the stationary lid member has a semi-cylindrical shape, and the closure panel has a semi-cylindrical shape, the stationary lid member and the closure panel together defining a cylindrical food cooking chamber.

12. The grill of claim 8, further comprising a housing portion located below the food cooking chamber and having a window through which flames from fuel burning in a combustion chamber located in the lower housing member can be seen.

13. The grill of claim 12, in which the window has a transparent pane.

14. The grill of claim 13, in which the transparent pane is a glass pane.

15. A cooking grill comprising:
an upper housing portion at least partially defining a food cooking chamber; and
a lower housing portion containing a combustion chamber located below the food cooking chamber, the lower housing having a window through which flame from fuel in the combustion chamber can be seen.

16. The grill of claim 15, in which the window has a transparent pane.

17. The grill of claim 16, in which the transparent pane is a glass pane.
